(19) United States
(12) Patent Application Publication
(10) Pub. No.: US 2003/0216599 A1
(43) Pub. Date: Nov. 20, 2003

(54) Synthesis of diphosphinoarenes

(76) Inventor: John Henry Hillhouse, Niagara Falls (CA)

Correspondence Address: Valerie T Didamo, Cytec Industries Inc, 1937 W Main Street, PO Box 60, Stamford, CT, 06904-0060, US

(21) Appl. No.: 10/276,074

(22) PCT Filed: May 3, 2001
(86) PCT No.: PCT/US01/14182

(30) Foreign Application Priority Data
May 31, 2000 (CA) 2,310,353

(51) Int. Cl. C07F 9/02

(52) U.S. Cl. 568/10

(57) ABSTRACT

This invention provides a process for the preparation of a diphosphinoarene, a corresponding phosphine oxide, or a corresponding phosphine sulphide, and derivatives thereof, which comprises reacting a primary or secondary phosphine, phosphine oxide, or phosphine sulphide with an aryl compound bearing two leaving groups attached to two different carbon atoms of the arylene bring system, in the presence of a catalyst comprising a Group VIIIa metal. Diphosphinoarenes may be used as ligands for metal catalysts, as solvent extractants for certain metals, and as flame retardants in polyester and polyurethane applications.

### FIELD OF THE INVENTION

This invention relates to the synthesis of diphosphinoarenes, corresponding phosphine oxides and phosphine sulphides, and derivatives thereof.

### BACKGROUND OF THE INVENTION

Diphosphinoarenes, corresponding phosphine oxides and phosphine sulphides, and their derivatives find many industrial uses, for instance as ligands of metal catalysts, as solvent extractants for certain metals, and as flame retardants in polyester or polyurethane applications.

There are several known processes for preparing these compounds, but these tend to have disadvantages. For instance, some processes involve the use of phosphine halides together with Grignard or organolithium reagents, which is undesirable owing to the difficulty in handling such compounds.

U.S. Pat. No. 5,550,295 describes the preparation of an arylalkylphosphine by reacting a primary alkylphosphine or a secondary alkylphosphine, with an arylhalide in the presence of a zero valence palladium catalyst. As described, when a primary alkylphosphine is used, an excess of two equivalents of arylhalide is employed, and the product is typically a diarylmonoalkylphosphine. When a secondary alkylphosphine is used, approximately 1.1equivalents of arylhalide is employed, and the product is typically a monoaryldialkylphosphine. U.S. Pat. No. 5,550,295 does not contemplate the preparation of an arene disubstituted by two phosphine moieties.

### SUMMARY OF THE INVENTION

The instant invention provides a process for preparing a diphosphinoarene, a corresponding phosphine oxide, and a corresponding phosphine sulphide, which comprises reacting a primary or secondary phosphine, phosphine oxide, or phosphine sulphide with an aryl compound bearing two leaving groups attached to two different carbon atoms of the arylene ring system, in the presence of a catalyst comprising a Group VIIIa metal.

### DESCRIPTION OF THE PREFERRED EMBODIMENTS OF THE INVENTION

Unless the context requires otherwise, the term diphosphinoarene as used herein shall include corresponding phosphine oxides and phosphine sulphides.

In preferred embodiments, the instant invention provides a process for the preparation of a diphosphinoarene of Formula I

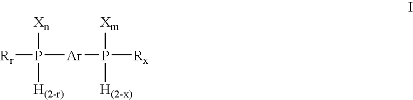

wherein

each R independently represents an unsubstituted or substituted C₁₋₂₀ alkyl group, C₃₋₈ cycloalkyl group, C₈₋₁₂ bicycloalkyl group, or C₆₋₁₄ aryl group;

x and r independently represent 1 or 2;

each X independently represents an oxygen atom or sulphur atom;

m and n independently represent 0 or 1; and

Ar represents an arylene group.

This process involves reacting a disubstituted arene of Formula II:

Q-Ar-Q II

wherein

each Q independently represents a leaving group and each of said leaving groups is attached to a different carbon atom of the arylene ring, and

Ar represents an arylene group;

with a mono- or disubstituted phosphine, phosphine oxide, or phosphine sulphide of Formula III

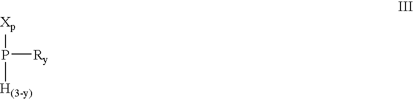

wherein

R represents an unsubstituted or substituted C₁₋₂₀ alkyl group, C₃₋₈ cycloalkyl group, C₈₋₁₂ bicycloalkyl group, or C₆₋₁₄ aryl group;

y represents 1 or 2;

X represents an oxygen atom or sulphur atom; and

p represents 0 or 1;

in the presence of a catalyst comprising a Group VIIIa metal, to form the diphosphinoarene of Formula I.

This reaction between a mono- or disubstituted phosphine, phosphine oxide, or phosphine sulphide, and the disubstituted arene of Formula II may produce in a first step a diphosphino product, a monophosphino product, or a mixture of both types of products. The relative proportion of the di- and monophosphino products depends on various factors, including the relative proportions of the phosphine of Formula III and arene reactant of Formula II, the positions of the leaving groups, Q, on the arene reactant, the identity of the leaving groups, the number and nature of R groups on the phosphine of Formula III, and the reaction conditions. Generally, the less steric hindrance and the greater the ratio of the mono- or disubstituted phosphine of Formula III to the disubstituted arene of Formula II, the greater the relative proportion of the diphosphino derivative.

The invention may be used to prepare diphosphinoarenes of Formula I that are symmetrical or asymmetrical. When a symmetrical diphosphinoarene of Formula I is required, two or more equivalents of a phosphine, phosphine oxide, or phosphine sulphide of Formula III are employed relative to the amount of disubstituted arene of Formula II employed, such that the diphosphinoarene of Formula I produced has two identical phosphino substituents on the arylene ring.

When the desired diphosphinoarene of Formula I is asymmetrical, two or more mono- or disubstituted phosphines, phosphine oxides, or phosphine sulphides of Formula III are employed. The two or more phosphines are reacted either simultaneously with the disubstituted arene of Formula II or consecutively.

In the latter case, the disubstituted arene of Formula II is reacted with a first mono- or disubstituted phosphine of Formula III, in the presence of a catalyst comprising a Group VIIIa metal, to form a monophosphinoarene of Formula XₙRᵣH₍₂₋ᵣ₎P—Ar-Q. Then, the monophosphinoarene may be reacted with a second phosphine of Formula III, in the presence of a catalyst comprising a Group VIIIa metal, to form the diphosphinoarene of Formula I. Alternatively, the second phosphine may be added by other procedures known in the art. For instance, the monophosphinoarene may be reacted with a phosphine halide in the presence of Grignard or organolithium reagent to afford a disphosphinoarene of Formula I. Examples of phosphine halides include diphenylchlorophosphine, which may be reacted in the presence of magnesium and ether with the monophosphinoarene.

The molar ratio of phosphine of Formula III and the disubstituted arene of Formula II can be equivalent, or either reactant can be used in excess. If it is desired to perform the reaction in one step, then the substituted phosphine of Formula III should be used in an amount equal to two molar equivalents or greater, say up to about five molar equivalents or greater relative to the amount of the disubstituted arene of Formula II. If it is desired to perform the reaction in two steps, then the phosphine of Formula III should be used in amount equal to one molar equivalent or less relative to the amount of the arene of Formula II, to first produce a monophosphinoarene. The monophosphinoarene obtained may then be further reacted with a second phosphine of Formula III present in an amount equal to one or more equivalents relative to the amount of monophosphinoarene to form a diphosphinoarene of Formula I.

Disubstituted Arene Reactant of Formula II: The disubstituted arene of Formula II can have only carbon atoms in the arylene ring, or can be heterocyclic containing one- or more nitrogen, oxygen or sulphur atoms. As examples of nitrogen-containing arylene rings, there are mentioned radicals derived from pyridine, pyrimidine, and pyrazine. As an oxygen-containing arylene ring there is mentioned a radical derived from furan. As a sulphur-containing heterocyclic arylene ring there is mentioned a radical derived from thiophene. Examples of hydrocarbyl arylenes include radicals derived from benzene, naphthalene, anthracene, and phenanthrene.

The arylene moiety can be unsubstituted or can be substituted by groups that do not interfere with the reaction. Suitable substituents include straight chained or branched C₁₋₈ alkyl and C₂₋₈ alkenyl groups, C₃₋₈ cycloalkyl groups, aryl groups such as phenyl or naphthyl, aralkyl groups such as benzyl or phenethyl, alkaryl groups such as tolyl or xylyl groups, C₂₋₈ acyl, C₂₋₈ acyloxy, C₁₋₈ alkoxy, C₂₋₈ alkenoxy, and C₆₋₁₄ aryloxy groups.

Preferred leaving groups, Q, of the arene of Formula II, are the halogens, particularly chlorine, bromine and iodine. Other suitable leaving groups include, for example, trifluoromethanesulphonyloxy (triflate), methanesulphonyloxy (mesylate), toluenesulphonyloxy (tosylate), and trifluoroacetate groups. The leaving groups are attached to carbon atoms of the arylene ring.

Preferred disubstitued arenes include 1,2 and 1,4 disubstituted arenes. Specifically mentioned are 1,2-dibromobenzene and 1,4-dibromobenzene.

Phosphine Reactant of Formula III: The phosphine reactant of Formula III may be a primary or secondary phosphine, phosphine oxide, or phosphine sulphide. The R groups can be the same or different, but frequently will be the same. The number of carbon atoms in the R group or groups is not critical and can range from 1 to 20 or even higher, and mention is made of groups having 4 to 15 carbon atoms. As an alkyl group, R can be straight-chained or branched. Examples of alkyl groups include isobutyl and 2,4,4-trimethylpentyl. If R is cycloalkyl, it preferably contains 3 to 8 carbon atoms, more preferably 5 or 6 carbon atoms. If R is bicycloalkyl, it preferably contains 8 to 12 carbon atoms, more preferably 8 to 10 carbon atoms. The alkyl, cycloalkyl, and bicycloalkyl groups may be interrupted by hetero atoms such as oxygen, nitrogen, or sulphur. As an aryl group, R preferably contains 6 to 14 carbon atoms, more preferably 6 carbon atoms. The aryl group may also be heterocyclic containing one or more nitrogen, oxygen, or sulphur atoms. Examples of aryl groups include phenyl, napthalenyl, and anthracenyl, and radicals derived from pyridine, pyrimidine, pyrazine, furan, and thiophene.

The R group can be substituted provided the substitutents do not interfere with the reaction. Suitable substituents include straight chained or branched C₁₋₈ alkyl groups, C₃₋₈ cycloalkyl groups, aryl groups such as phenyl or naphthyl, aralkyl groups such as benzyl or phenethyl, alkaryl groups such as tolyl or xylyl groups, C₂₋₈ acyl, C₂₋₈ acyloxy, C₁₋₈ alkoxy, C₂₋₈ alkenoxy, and C₆₋₁₄ aryloxy groups.

Preferably, in the reactant of reactant of Formula III, p is 0. In other words, the reactant is preferably a phosphine rather than a phosphine oxide or phosphine sulphide.

Preferred phosphines include mono 2,4,4-trimethylpentyl phosphine, monocyclohexyl phosphine, and diisobutyl phosphine.

Catalyst: The reaction is carried out in the presence of a catalyst that is a Group VIIIa metal or a complex thereof. The preferred Group VIIIa metals are nickel and palladium, of which the more preferred is palladium. The catalysis can be heterogeneous or homogeneous.

Heterogeneous catalysts include palladium, platinum, rhodium, ruthenium, and nickel metal. The metal can be unsupported, or can be supported on a solid support such as, for example, carbon, alumina, silica or an organic polymer, for example polystyrene. Mention is made of palladium on carbon, alumina, and on silica, and palladium/polyethyleneimine (PEI) on silica catalysts. These types of catalysts are commercially available from Aldrich Chemical Company, Wisconsin. Palladium on carbon and palladium on alumina catalyst particles are usually of a mesh size in the range of about 100 to 200. Palladium on polystyrene is usually a fibre that is about 2 to 5 mm in length. Palladium/PEI on silica particles are usually of a mesh size in the range of about 20 to 40.

Catalysts composed of about 5% to about 10% of palladium metal on carbon are used in organic synthesis in high pressure hydrogenation reactions, and such catalysts are suitable for the present invention. The preferred heterogeneous catalyst is finely divided palladium metal on a carbon support.

Catalysts which are heterogeneous have the advantage that they are readily separated from the reaction mixture by, for example, filtration or decantation, which assists in the economical work-up of the reaction products and in recycling the catalyst.

The heterogeneous catalyst recovered from the reaction mixture can be washed one or more times, as necessary, to remove any salts, water (derived from the work-up) unreacted starting materials and product absorbed on the catalyst. The catalyst may be washed with water-immiscible solvents, for example aromatic solvents such as toluene or xylene, water-miscible organic solvents such as acetone or alcohols and water itself, prior to drying and reuse.

Homogeneous catalysts include zero valence compounds of palladium, examples of which include tetrakis(triphenyl-phosphine)palladium, 1,2bis(diphenylphosphine)ethane palladium, dichlorobis(triphenylphosphine)palladium, 1,3-bis(diphenylphosphine)-propane palladium, 1,4-bis(diphenyl-phosphine)butane palladium and 1,1-bis(diphenylphosphine)-ferrocene palladium.

Other homogeneous catalysts of the invention include adducts of a Pd(II) salt and a tertiary phosphine, especially 1:1. As palladium salts there are mentioned the diacetate and the dichloride. The tertiary phosphine can be a trialkylphosphine, for instance, tri(ethyl)-, tri(propyl)-, tri(n-butyl)-, tri(isobutyl)-, tri(cyclopentyl)-, tri(cyclohexyl)- and tri(n-octyl)phosphine or a triarylphosphine, of which triphenylphosphine and tri(ortho-tolyl)phosphine are preferred. One preferred catalyst is an adduct of palladium (II) acetate and tris(o-tolyl)phosphine and is described (in German) by Wolfgang A. Herrmann et al., in Angew. Chem., 1995, Volume 107, pages 1989-1992 and (in English translation) in Angew. Chem. Int. Ed. Engl., 1995, Volume 34, pages 1844-1848, the disclosure of which is incorporated herein by reference.

Homogeneous catalysts of the invention include palladium compounds that are standard π donors, for instance Pd[cyclooctadiene]₂, Pd[cyclopentadiene]₂ and Pd[dibenzylacetone]₂.

It is possible to form the homogeneous catalyst and then add it to the reaction vessel, or it is possible to add the components of the homogeneous catalyst, so that the catalyst is formed in situ.

The amount of catalyst employed can range from about 0.01 mole to about 10.0 mole percent, preferably from about 0.05 to about 5 mole percent, more preferably from about 0.05 to about 1 mole percent, based on the amount of the substituted arene of Formula II charged.

Solvent: The reaction is preferably carried out in the presence of a solvent. Suitable solvents include glyme, acetonitrile, diethyl ether, anisole, di-n-butyl ether, tetrahydrofuran, p-dioxane, toluene, xylene, cumene, or a mixture of toluene and isopropanol (e.g. a 3:1 mixture). Also suitable are aliphatic, cycloaliphatic, and aromatic hydrocarbons, including hexane, heptane, octane, cyclohexane, benzene, and petroleum fractions boiling at 70 to 140° C. Solvents that have oxidizing properties, such as DMSO, should be avoided. o-Xylene and toluene are preferred.

Additional Reagents: The reaction is preferably carried out in the presence of a base. Suitable bases include sodium hydroxide, potassium hydroxide, sodium carbonate, potassium carbonate, calcium carbonate, sodium bicarbonate, potassium carbonate, sodium ethoxide, potassium ethoxide, ammonium carbonate, ammonium bicarbonate, calcium oxide, calcium hydroxide, magnesium oxide, magnesium hydroxide or the like. Organic bases, particularly amines, can also be used. Mention is made of pyridine and pyridine derivatives and tertiary amines of which triethylamine, tributylamine, and other trialkylamines are preferred.

Reaction Conditions: The reaction can be carried out at ambient or elevated temperature but usually a temperature of about 170° C. is not exceeded, and a temperature in the range from about 70° to about 160° C., particularly about 110° to about 145° C., is preferred. At lower temperatures the reaction takes longer, but reaction is usually complete in a period of about 2 hours to 2 weeks, and usually within 50 hours. The reaction is usually carried out at atmospheric pressure, but elevated pressure can be used if desired. Elevated pressure may be advantageous with alkylphosphine, reactants of low molecular weight. For instance, with methyl- or ethyl- or propylphosphine, an autoclave can be used. Pressure will not normally be more than about 600 psig and will preferably be within the range of about 50 to 500 psig. The reaction is preferably carried out under a blanket of inert gas, suitably argon or nitrogen. Efficient-stirring assists reaction and can be provided by, for instance, a magnetic stirrer or an overhead stirrer with paddle.

The diphosphinoarene of Formula I can be further reacted to make other useful products. Examples of such products are discussed below:

Phosphinic Acids: A diphosphinoarene of Formula I can be oxidized to form the corresponding phosphinic acid. The oxidation reaction may be performed in the presence of two or more equivalents of oxidizing agent based on the amount of phosphino groups, and in the presence of a catalytic amount of mineral acids. Suitable mineral acids include H₂SO₄ and HCl. Nitric acid is not a suitable mineral acid. Examples of oxidizing agents include hydrogen peroxide. Phosphinic acids may be useful as solvent extractants.

Phosphine oxides and phosphine sulfides: Assuming p is 0 in Formula III, the resulting mono-or diphosphino arene of Formula I can be converted to the corresponding phosphine oxide or sulphide by procedures known in the art. With reference to the corresponding oxide, the oxidation requires 1 equivalent of oxidizing agent per equivalent of phosphino group to be oxidized.

Hydroxyalkylphosphine oxides: A diphosphinoarene of Formula I can be converted into a corresponding hydroxyalkylphosphine oxide, by procedures known in the art. For example, the reaction of a diphosphinoarene of Formula I, wherein r and x are both 1, with allyl alcohol in the presence of azobisisobutyronitrile in toluene, followed by an oxidation in the presence of hydrogen peroxide yields a hydroxypropylphosphine oxide. The reaction of a diphosphinoarene of Formula I, wherein r and x are both 1, with formaldehyde in the presence of an acid, examples of which include sulphuric acid, p-toluene sulphonic acid, methanesulphonic acid, and phosphoric acid, followed by an oxidation in the presence of an oxidant, such as hydrogen peroxide, yields a hydroxymethylphosphine oxide. Hydroxyalkylphosphine oxides are useful as flame retardants in polyester or polyurethane applications.

Phosphonium Salts: The diphosphinoarenes of Formula I can be converted into their corresponding phosphonium salts by the addition of an alkyl halide or acid. Preferred acids are hydrogen bromide and hydrogen chloride. The alkyl group of the alkyl halide may be an unsubstituted or substituted alkyl or aryl group. The halide may be bromide, chloride, or iodide. Examples of solvents which may be used in the reaction include acetonitrile, DMF, alcohols, toluene, and xylenes. Phosphonium salts may be useful as phase transfer catalysts.

The invention is further illustrated in the following examples.

### EXAMPLES

### Example 1

### Reaction of mono 2,4,4-trimethylpentylphosphine (MTMPP) with 1,4-dibromobenzene

124 g (0.84 mol) of MTMPP was mixed with 96 g (0.4 mol) of 1,4-dibromobenzene in the presence of 84 g (0.84 mol) of triethylamine, 0.7 g (7.5×10⁻⁴ mol) of palladium dimer (1:1 adduct of palladium (II) acetate and tri(o-tolyl)phosphine) in 225 ml of o-xylene. The reaction mixture was heated and allowed to reflux with stirring at approximately 125° C. under nitrogen for approximately 41 hours at which time the reaction was judged complete by GC/FID. The ratio of 1,4-bis(mono-2,4,4-trimethylpentylphosphino)benzene to 1-(mono-2,4,4-trimethylpentylphosphine)-4-bromo-benzene produced was 97.3:2.6 (i.e. 37:1 of diphosphinoarene to monophosphino-arene). Approximately 100% of the 1,4-dibromobenzene was converted after forty-one hours.

### Example 2

### Reaction of diisobutylphosphine (DIBP) with 1,2-dibromobenzene

123 g (0.84 mol) of DIBP was mixed with 100 g (0.42 mol) of 1,2-dibromobenzene in the presence of 85 g (0.85 mol) of triethylamine, 0.7 g (7.5×10⁻⁴ mol) of palladium dimer (1:1 adduct of palladium (II) acetate and tri(o-tolyl)phosphine) in 225 ml of o-xylene. The reaction mixture was heated and allowed to reflux with stirring at approximately 135° C. under nitrogen for about 35 hours. At this time, the ratio of 1,2-bis(diisobutylphosphino)benzene to 1-(diisobutylphosphino)-2-bromo-benzene was 3.3:69 (i.e. 1:21 of diphosphinoarene to monophosphinoarene). Approximately 62% of the 1,2-dibromobenzene was converted after thirty-five hours.

### Example 3

### Reaction of mono 2,4,4-trimethylpentylphosphine (MTMPP) with 1,2-dibromobenzene

122 g (0.84 mol) of MTMPP was combined with 98 g (0.42 mol) of 1,2-dibromobenzene in the presence of 84 g (0.84 mol) of triethylamine and 0.7 g (7.5×10⁻⁴ mol) of palladium dimer (1:1 adduct of palladium (II) acetate and tri(o-tolyl)phosphine) in 200 mL xylene. The mixture was maintained at reflux (125° C.) under nitrogen with magnetic stirring for 12 hours. At this time, the conversion of the aryl halide was judged by GC/FID to be approximately 20%, with monoalkylphosphino-2-bromobenzene as the sole observed product. The reaction mixture was washed with an equal volume of water to remove the triethylamine hydrobromide, then stripped of unreacted starting materials and xylene under vacuum to afford the intermediate alkylarylphosphine (PNMR—20 ppm), 1-(2,4,4-trimethylpentylphosphine)-2-bromo-benzene.

1. A process for the preparation of a diphosphinoarene, a corresponding phosphine oxide, or a corresponding phosphine sulphide, which comprises reacting a primary or secondary phosphine, phosphine oxide, or phosphine sulphide with an aryl compound bearing two leaving groups attached to two different carbon atoms of the arylene ring system, in the presence of a catalyst comprising a Group VIIIa metal.

2. A process for the preparation of a diphosphinoarene of Formula I 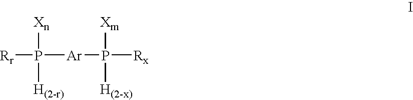
wherein
each R independently represents an unsubstituted or substituted C₁₋₂₀ alkyl group, C₃₋₈ cycloalkyl group, C₈₋₁₂ bicycloalkyl group, or C₆₋₁₄ aryl group;
x and r independently represent 1 or 2;
each X independently represents an oxygen atom or sulphur atom;
m and n independently represent 0 or 1; and
Ar represents an arylene group;
which comprises reacting a disubstituted arene of Formula II:
Q-Ar-Q II
wherein
each Q independently represents a leaving group and each of said leaving groups is attached to a different carbon atom of the arylene ring, and
Ar represents an arylene group;
with a mono- or disubstituted phosphine, phosphine oxide, or phosphine sulphide of Formula III 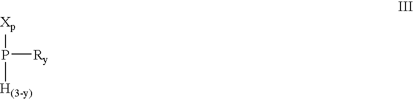
wherein
R represents an unsubstituted or substituted C₁₋₂₀ alkyl group, C₃₋₈ cycloalkyl group, C₃₋₁₂ bicycloalkyl group, or C₆₋₁₄ aryl group;
y represents 1 or 2;
X represents an oxygen atom or sulphur atom; and
p represents 0 or 1;
in the presence of catalyst comprising a Group VIIIa metal, to form the diphosphinoarene of Formula I.

3. The process according to claim 2, wherein each R is independently selected from the group comprising isobutyl and 2,4,4-trimethylpentyl.

4. The process according to claim 2 or 3, wherein m, n, and p equal 0.

5. The process according to claim 2, 3, or 4, wherein Ar is phenylene.

6. The process according to any one of claims 2 to 5, wherein each Q is selected from the group comprising chloride, bromide, iodide, triflate, mesylate, tosylate, and trifluoroacetate.

7. The process according to any one of claims 2 to 6, wherein the diphosphino arene of Formula II is selected from the group comprising 1,2-dibromobenzene and 1,4-dibromobenzene.

8. The process according to any one of claims 1 to 7, wherein the catalyst is a homogeneous catalyst.

9. The process according to claim 8, wherein the catalyst is selected from the group comprising tetrakis(triphenylphosphine)palladium and the 1:1 adduct of palladium(II) acetate and tri(o-tolyl)phosphine.

10. The process according to any one of claims 1 to 7, which is carried out in the presence of a base.

11. The process according to claim 9, wherein the base is triethylamine.
